(19) United States
(12) Patent Application Publication
(10) Pub. No.: US 2026/0236491 A1
(43) Pub. Date: Aug. 13, 2026

(54) METHOD OF ENCODING AND STORING GEODATA

(71) Applicant: FNV IP B.V., Leidschendam (NL)

(72) Inventors: Jorg DONAT, Leidschendam (NL); Thomas ANDERS, Leidschendam (NL)

(73) Assignee: FNV IP B.V., Leidschendam (NL)

(21) Appl. No.: 19/153,021

(22) PCT Filed: Feb. 8, 2024
(86) PCT No.: PCT/EP2024/053115

§ 371 Date: Aug. 1, 2025

(30) Foreign Application Priority Data
Feb. 13, 2023 (NL) 2034135

(51) Int. Cl. G06F 16/29

(52) U.S. Cl. CPC G06F 16/29

(57) ABSTRACT

A computer-implemented method of encoding and storing geodata, the method comprising receiving a selection of a database object comprising geodata, receiving a selection of at least one characteristic of the geodata, loading a dictionary of geodata characteristic codes, receiving a selection of a geodata characteristic code in the dictionary of geodata characteristic codes, encoding the selected characteristic of the geodata, using the selected geodata characteristic code, and storing the encoded characteristic of the geodata. Unlocking insights from Geo-Data, the present invention further relates to improvements in sustainability and environmental developments: together we create a safe and liveable world.

### FIELD

The disclosure relates to methods and systems for encoding and storing geodata. More particularly, the disclosure relates to methods and systems for encoding geodata using standardised geodata characteristic codes and storing geodata in a computationally efficient manner. Unlocking insights from Geo-Data, the present invention further relates to improvements in sustainability and environmental developments: together we create a safe and liveable world.

### BACKGROUND

There is a general and ongoing need for systems and methods for determining sub-surface ground parameters. In particular, there is a need for systems and methods that can be used to model the properties of a target volume beneath the surface of the earth to provide information useful for infrastructure planning. There is also a need to determine sub-surface soil composition and structure. Determination of sub-surface ground properties in this manner during the early planning phase of construction projects reduces uncertainty during the location determination, foundation design, and construction phases of a project. This in turn reduces delays, overspend, and unnecessary use of material resources (e.g. concrete) during construction.

A variety of techniques can be used to ascertain the properties of a target sub-surface volume. These include down-hole and cross-hole techniques whereby one or more boreholes are drilled and soil samples obtained from the borehole are analysed. Other geological entities such as ground water wells can also be studied. Geological data (referred to herein as geodata) can also be obtained through seismology, from climate measurement stations and through a variety of other similar geological entities and investigations. Such geological study typically yields a large amount of geodata from a variety of sensors and data sources. Processing, storing and outputting such a large amount of geodata in a way that is computationally efficient, conforms with often complex and varying standards for representation of geodata, and is intuitively understandable to an analyst is problematic, due to the volume of data and the fact that data often comes from many different locations and data sources.

There is a need to provide improved mechanisms for processing, sorting, standardising, and outputting such geodata in a manner that is computationally efficient, conforms with standards for representation of geodata, and facilitates easy and intuitive understanding of data and comparison between data arising from different geological entities and data sources.

### OVERVIEW

According to a first aspect of the present disclosure, there is provided a computer-implemented method of encoding and storing geodata. “Geodata” in this context means geological data, in other words any form of data obtained through geological study pertaining to one or more properties of a sub-surface volume, particularly ground (e.g. soil, rock, water) characteristics. Geological data can be used in contexts such as borehole logs, well design, data sequence graphs and so on. The method comprises: receiving a selection of a database object comprising geodata; receiving a selection of at least one characteristic of the geodata; loading a dictionary of geodata characteristic codes; receiving a selection of a geodata characteristic code in the dictionary of geodata characteristic codes; encoding the selected characteristic of the geodata, using the selected geodata characteristic code; and storing the encoded characteristic of the geodata.

This enables geodata stored in a database object to be encoded using at least one standardised geodata characteristic code in a computationally efficient manner. No programming is required, the user simply selects the characteristic of the geodata to be encoded along with the desired geodata characteristic code. The characteristic is then encoded and stored. It also means that any data linked to the geodata characteristic code can be retrieved and output in a computationally efficient manner by merely retrieving the encoded characteristic of the geodata.

The selected geodata characteristic code may be linked to a first text string related to the characteristic of the selected geodata characteristic code. This enables data about the encoded characteristic of the geodata to be retrieved and output in the form of a first text string. In this manner, the data is more readily retrievable and can be accessed in a computationally efficient manner.

The selected geodata characteristic code may be linked to a second text string related to the characteristic of the selected geodata characteristic code and in a different language to the first text string. This enables first text string data of the encoded characteristic of the geodata to be retrieved and output in different languages in a computationally efficient manner. It also means that local requirements for the description of geodata characteristics can be taken into account. For example, if the first text string is in German and the second text string is in English, any differences in the way in which a geodata characteristic needs to be described in those languages, for example to conform with a standard, can readily be taken into account using this data structure format.

The selected geodata characteristic code may be linked to a fill pattern related to the characteristic of the selected geodata characteristic code. This enables a fill pattern associated with the encoded characteristic of the geodata to be retrieved and output in a computationally efficient manner.

A respective fill pattern related to the characteristic of the selected geodata characteristic code may be linked to each of the first text string and the second text string. This enables different fill patterns to be linked to each of the first text string and the second text string. In scenarios where a different fill pattern is required for each of the first and second languages, this means that the fill patterns can be retrieved and output in a computationally efficient manner.

The method may further comprise the step of displaying geodata characteristic codes in the dictionary of geodata characteristic codes, wherein receiving a selection of a geodata characteristic code in the dictionary of geodata characteristic codes comprises receiving a selection of a displayed geodata characteristic code.

The method may further comprise the step of receiving a selection of a standard, wherein the step of displaying geodata characteristic codes in the dictionary of geodata characteristic codes comprises displaying a subset of the geodata characteristic codes in the stored dictionary of geodata characteristic codes that conform with the standard, wherein the selected geodata characteristic code is selected from the displayed subset of geodata characteristic codes that conform with the standard. This ensures that only geodata characteristic codes relevant to a selected standard are displayed, improving the computational efficiency associated with providing the method of storing geodata.

The method may further comprise receiving a selection of a layer in a geological entity associated with the geodata of the database object, wherein the step of receiving a selection of a characteristic of the geodata comprises receiving a selection of a characteristic of the layer. This enables the geodata of the database object to be split up into layers and for characteristics of each of those layers to be encoded. In this manner, the geodata is retrievable in a more computationally efficient manner.

The characteristic of the geodata may comprise at least one of: principal soil type, principal rock type, plasticity, carbonate content, stratification, relative density, rock strength, particle type, particle shape, grading, colour, co-ordinate system, EPSG code, stop criterion, water depth measurement methods, test standards, cones, adaptors, laboratory, casing material, drilling equipment, drilling method, backfill; and, sample type, type of test, sample condition.

The database object may be associated with a geological entity comprising one or more of: a borehole, a groundwater well, a climate measurement station, a soil container, or a water container. Each database object (and the geodata it contains) can relate to a variety of geological entities and locations.

The geodata may comprise data obtained from a plurality of data sources. Each data object can include data from a plurality of sources, e.g. borehole logs, general data, sample data, pictures, data sequences (as CPT and similar), field and laboratory measurement data, well design data, groundwater data.

The method may further comprise receiving a selection of a second characteristic of the geodata; receiving a selection of a second geodata characteristic code in the dictionary of geodata characteristic codes; encoding the selected second characteristic of the geodata, using the selected second geodata characteristic code; and storing the encoded second characteristic of the geodata. Multiple characteristics of a database object can be encoded and stored, meaning that any data linked to the second geodata characteristic code can be retrieved and output in a computationally efficient manner. This is useful because geological projects often contain database objects with multiple characteristics.

The method may further comprise receiving a selection of a second layer in a geological entity associated with the geodata of the database object, wherein the step of receiving a selection of a second characteristic of the geodata comprises receiving a selection of a characteristic of the second layer. This enables characteristics of different layers of the database object to be encoded.

The method may further comprise receiving a selection of a third geodata characteristic code, wherein the selected characteristic of the geodata is encoded using the selected geodata characteristic code and the selected third geodata characteristic code. This enables a selected characteristic of the geodata to be encoded using multiple codes. In practice, this could look like combining codes for soil type and consistency (e.g. silty clay +very soft).

The selected third geodata characteristic code may be linked to a third fill pattern related to the characteristic of the selected third geodata characteristic code. This enables multiple fill patterns to be provided for the same characteristic of the geodata. In practice, this would look like combining fill patterns for soil type and consistency (e.g. silty clay+very soft).

The method may further comprise receiving an instruction to output a report comprising the geodata of the database object; retrieving the encoded characteristic of the geodata; decoding the encoded characteristic of the geodata to obtain data linked to the encoded characteristic of the geodata; and outputting the linked data in a report. In this manner, an output of the encoded geodata can be obtained from the system. This can be digital (e.g. a PDF) or a physical printout sent to a printer.

According to another aspect of the present disclosure, there is provided a system comprising one or more processors and one or more memories having stored thereon computer-readable instructions configured to cause the one or more processors to perform any of the methods disclosed herein.

According to another aspect of the present disclosure, there is provided a computer-readable medium comprising instructions, that, when executed by one or more data processing apparatus, cause the one or more data processing apparatus to perform any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF THE DRAWINGS

Disclosed implementations will now be described by way of example to illustrate aspects of the disclosure and with reference to the accompanying drawings, in which:

FIG. 1 shows, schematically, a system that can be used to implement the disclosed methods;

FIG. 2 shows an example geodata characteristic code that can be used in the disclosed methods;

FIG. 3 shows a method of encoding and storing geodata according to the present disclosure;

FIGS. 4-7 demonstrate example implementations for configuring database objects of the present disclosure;

FIGS. 8-12 show example implementations of how a dictionary that can be used in the disclosed methods is structured;

FIGS. 13-15 demonstrate example implementations for encoding characteristics of geodata using a geodata characteristic code in accordance with the present disclosure; and

FIG. 16 shows a block diagram of a computing device which can be used to implement the disclosed methods.

### DETAILED DESCRIPTION

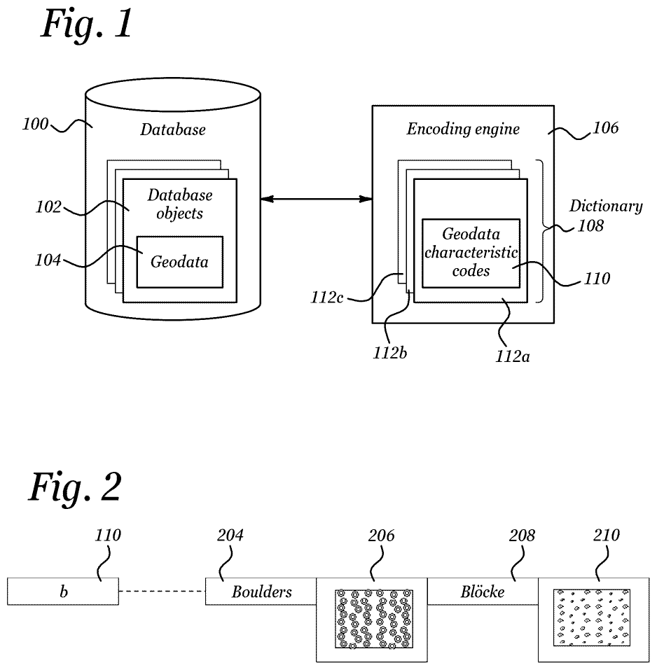

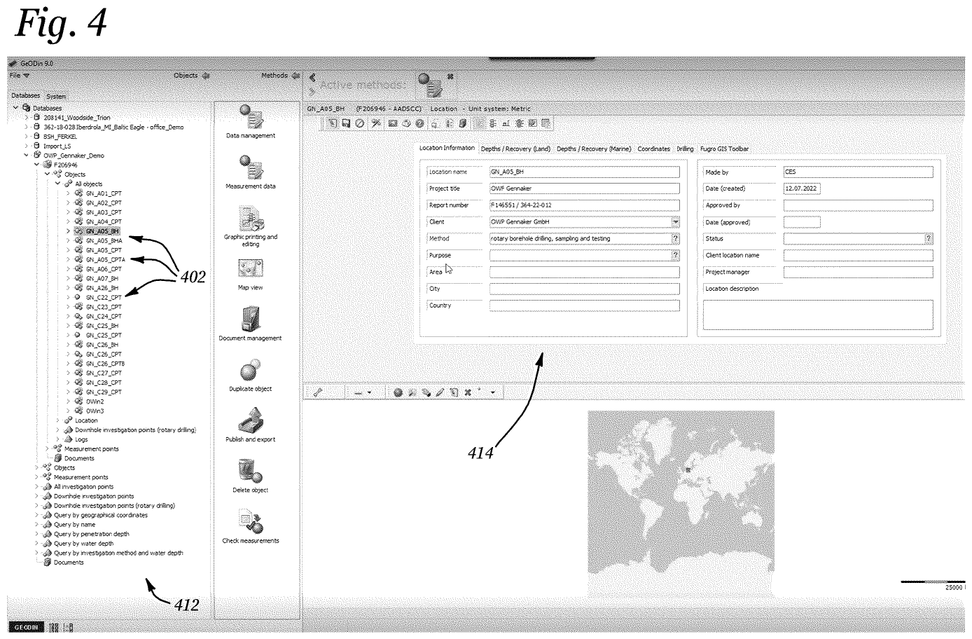

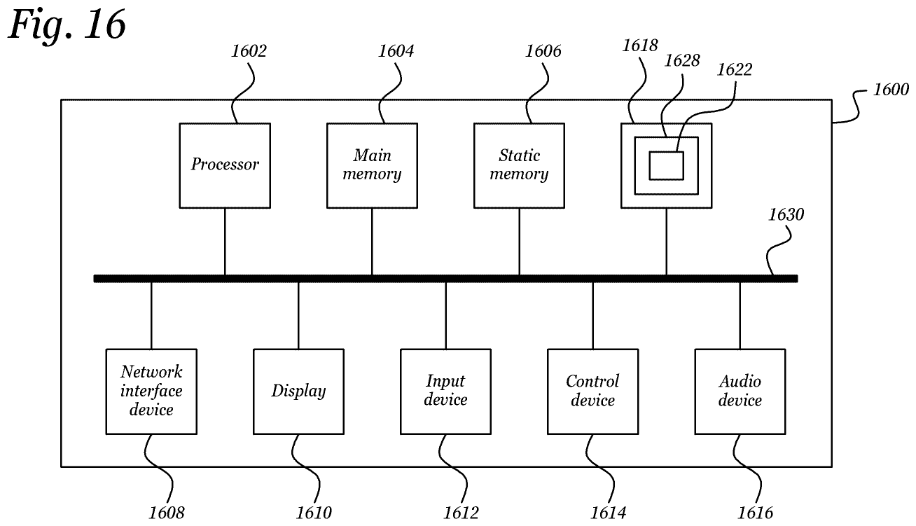

This detailed description describes, with reference to FIGS. 1-3, systems and methods for providing improved processing, storing and outputting of geodata that provides a better user-machine interface and enables select data from a geodata database to be quickly and efficiently obtained, encoded, stored and outputted in a manner that conforms with standards, without requiring any programming or the opening of multiple programs or display windows. Example implementations showing how the disclosed systems and methods can be used to encode characteristics of geodata in database objects are shown with reference to FIGS. 4-15. Finally, a computing device that may be used to perform the disclosed methods is described with reference to FIG. 16.

The methods and systems disclosed herein relate generally to processing, storing and outputting geodata using a dictionary of geodata characteristic codes to encode characteristics of the geodata. No programming is required, the user simply selects the characteristic of the geodata to be encoded along with the desired geodata characteristic code. The characteristic is then encoded and stored. It also means that any data linked to the geodata characteristic code, such as fill pattern data and related text strings, can be retrieved and output in a computationally efficient manner by merely retrieving the encoded characteristic of the geodata. Through this approach, geodata can also be encoded in a manner that automatically adheres to standards in a computationally efficient manner. The disclosed systems and methods address problems with existing geodata processing and storage systems, which would require a variety of programs to be used in order to generate and attribute characteristics to geodata in a required format. Prior to the methods and systems described herein, digital geological representations of soil and rock were primarily drawn in image editing programs. Often, a degree of programming was required at use time from the end user in order to ensure the correct geodata characteristics were attributed to the geodata and in the correct format. There was previously no single, unified system that was capable of retrieving processing, storing and outputting geodata in an efficient and intuitive manner based on only very basic user inputs. The disclosed systems and methods address these deficiencies and provide an improved geodata processing system.

Turning first to FIG. 1, a system that can be used to implement the disclosed methods is shown schematically. A database 100 is shown containing a plurality of database objects 102. A database object in the context of the present disclosure can be considered as a set or bundle of geodata 104 associated with a particular geological entity, geological test or geological experiment. The set of geodata 104 in each database object 102 may comprise data obtained from a plurality of data sources. For example, a particular example database object 102 may comprise a variety of geodata 104 relevant to a particular borehole. This borehole geodata may comprise data obtained through a variety of means and from a number of sources, such as data obtained using a cone penetrometer test (CPT), data from lab or field-based experiments on soil samples taken from the borehole, seismology data obtained from or around the borehole, or data from any other suitable sensor or measuring device associated with the borehole in question. All this geodata for the given borehole can then be grouped as a database object 102 and stored within database 100. Other database objects 102 will similarly contain sets of geodata 104 associated with different respective geological entities. Geological entities may include boreholes, groundwater wells, climate measurement stations, soil containers, water containers or any other suitable entity, geological site or test from which geological data can be obtained. Geodata 104 may accordingly contain any suitable data obtainable from such geological entities, including but not limited to borehole logs, general geological site data, soil sample data, pictures of the geological entity, data sequences (such as obtained through a CPT experiment), field and laboratory measurement data, well design data, groundwater data and so on. Geodata 104 is made up of characteristics, which are described in more detail below.

Also shown in FIG. 1 is an encoding engine 106. This encoding engine 106 is configured to implement the methods disclosed herein, in order to encode characteristics of the geodata 104, obtained from database objects 102, using geodata characteristic codes 110 stored in a dictionary 108. The encoding engine 106 may comprise the dictionary 108, although the dictionary 108 may be remote from the encoding engine 106 and accessed by the encoding engine 106 via, for example a network. The dictionary 108 comprises a plurality of dictionary entries 112a, 112b, 112c which each comprise a set of corresponding geodata characteristic codes 110.

Each dictionary entry 112a, 112b, 112c may correspond to a respective standard, meaning that the geodata characteristic codes 110 contained within each dictionary entry 112a, 112b, 112c all relate to the same standard. For example, dictionary entry 112a may relate to EN ISO 14688/14689(2018 ), in which case all geodata characteristic codes 110 within dictionary entry 112a also relate to EN ISO 14688/14689(2018 ) in that they conform with the requirements of the standard. Similarly, dictionary entry 112b may relate to ASTM D2487, in which case all geodata characteristic codes 110 within dictionary entry 112b also relate to ASTM D2487 in that they conform with the requirements of that standard. Similarly, dictionary entry 112c and the geodata characteristic codes 110 contained therein may conform with yet another standard.

The geodata characteristic codes 110 are the elements actually used to encode characteristics of the geodata 104. Each geodata characteristic code 110 may comprise an identifier that is linked to further data elements related to the characteristic of that particular geodata characteristic code 110.

Examples of characteristics of geodata to which geodata characteristic codes 110 may relate include at least the following:
Soil/Rock properties such as: principal soil type, principal rock type, plasticity, carbonate content, stratification, relative density, rock strength, particle type, particle shape, grading, colour;
General data such as: co-ordinate system, EPSG code, stop criterion, water depth measurement methods;

Laboratory test data as: test standards, cones, adaptors, laboratory;
Well design data as: casing material, drilling equipment, drilling method, backfill; and
Sample data as: sample type, type of test, sample condition.

Examples of data elements to which geodata characteristic codes can be linked include text strings (e.g. standard specific text strings), translations of text strings in other languages, standard specific genus, standard specific fill patterns, standard specific symbols and their intensity, groups, quantifications, and similar.

The encoding engine 106 may be in communication with the database 100 via, for example, a network. Alternatively, the encoding engine 106 may comprise the database 100 and may be in local communication with the database 100 without the need for a network.

FIG. 2 depicts an example geodata characteristic code 110. In this example, geodata characteristic code 110 takes the form “b” which represents the geodata characteristic of principle soil type, specifically “boulders” in this example. It will be understood that this is just an example and geodata characteristic codes 110 related to any of the characteristics of geodata described herein can be provided. The example geodata characteristic code 110 depicted in FIG. 2 is linked to a first text string 204 related to the characteristic of the depicted geodata characteristic code 110. In this example, the first text string 204 takes the form “Boulders”, in other words, an English language representation of the principle soil type characteristic, boulders, to which the geodata characteristic code 110 relates. The first text string 204 could also include additional information related to the characteristic of the geodata characteristic code 110, further defining the characteristic. The first text string 204 may conform with an English language version of a standard, such as EN ISO 14688/14689(2018 ).

The geodata characteristic code 110 is also linked to a first fill pattern 206 related to the characteristic of the depicted geodata characteristic code 110. In this example, the first fill pattern 206 is a visualisation of the principle soil type characteristic, boulders, to which the depicted geodata characteristic code 110 relates. More generally, a fill pattern is a graphical representation of a geodata characteristic. In this example, the first fill pattern 206 conforms with first text string 204. For example, where the content of the first text string 204 conforms with an English language version of a standard, such as EN ISO 14688/14689(2018 ), the first fill pattern 206 also conforms with the English language version of the standard.

The geodata characteristic code 110 is linked to a second text string 208 related to the characteristic of the geodata characteristic code 110. In this example, the second text string 208 takes the form “Blocke”, in other words, a German language representation of the principle soil type characteristic, boulders, to which the depicted geodata characteristic code 110 relates. The second text string 208 could also include additional information related to the characteristic of the geodata characteristic code 110, further defining the characteristic. The second text string 208 may conform with a German language version of a standard, such as EN ISO 14688/14689(2018 ). The second text string 208 may conform with a German language version of the standard to which the first text string 204 relates.

The geodata characteristic code 110 is also linked to a second fill pattern 210 related to the characteristic of the depicted geodata characteristic code 110. In this example, the second fill pattern 210 is a visualisation of the principle soil type characteristic, boulders, to which the depicted geodata characteristic code 110 relates. In this example, the second fill pattern 210 conforms with second text string 208. For example, where the content of the second text string 208 conforms with German language version of a standard, such as EN ISO 14688/14689(2018 ), the second fill pattern 210 also conforms with the German language version of the standard. In this instance, the second fill pattern 210 is different to the first fill pattern 206 as the German language version of the standard has different requirements to the English language version.

It will be appreciated that geodata characteristic code 110 can be used to encode geodata in such a way that text strings and fill patterns conforming with different language versions of the same standard can be stored and retrieved in a computationally efficient manner.

Fill patterns, such as the first fill pattern 206 and the second fill pattern 210, may be graphical representations of a geodata characteristic. In some examples, fill patterns may include one or more of tables, graphical plots and any other suitable schematic representation, plot or diagram suitable for displaying geodata 104 or characteristics of geodata 104.

The encoding engine 106 is configured to retrieve geodata 104 from database objects 102 in database 100. Characteristics of the geodata 104 can then be encoded using one or more geodata characteristic codes 110 stored in the dictionary 108. The encoding engine 106 can then store the encoded characteristic, as described herein. This enables the characteristics of the geodata 104 to be retrieved, alongside one or more geodata characteristic codes 110 and any further data items linked to the one or more geodata characteristic codes 110 with which the characteristic of the geodata 104 has been encoded, in a computationally efficient manner. The geodata 104 can be retrieved and characteristics of the geodata 104 encoded responsive to receiving user selections of a particular a database object 102, a characteristic of the geodata 104 and one or more geodata characteristic codes 110

Retrieval of the geodata 104 from database object 102 for encoding can be achieved in a variety of ways, the details of which will be apparent to a skilled reader. Merely as one example, retrieving of geodata 104 can comprise populating a macro function with an address of the relevant database object 102, responsive to selection of that database object 102. A macro is generally understood as a single instruction that expands automatically into a set of instructions to perform a particular task. This macro can then enable geodata 104 to be retrieved (also referred to as being “pulled” or “called”) from the database object 102. Other mechanisms by which the geodata 104 can be retrieved from the database object 102 following selection of that database object 102 will be apparent to a skilled reader and can be used in the context of the present disclosure.

The encoding engine 106 may be configured to print a report comprising data associated with a stored encoded characteristic of the geodata 104. In order to do this, the encoding engine 106 may retrieve the encoded characteristic of the geodata 204, decode the encoded characteristic of the geodata 104 to obtain data items linked to the encoded characteristic of the geodata and output the linked data items in a report. The report can be printed in a digital form (for example as a PDF document) or as a physical report by sending an appropriate instruction to a printer. In this manner, characteristics of geodata can be output in a format that conforms with the requirements of the standards to which the geodata characteristic codes 110 used relate in a computationally efficient manner.

The encoding engine 106 may provide a suitable graphical user interface, GUI, configured to effectively display and facilitate user selection of database objects 102, geodata 104, characteristics of geodata 104, geodata characteristic codes 110, dictionaries 108, dictionary entries 112a, 112b, 112c, geodata characteristic codes 110 and the like. Example GUIs which can be provided are shown in the examples described in more detail below, particularly in FIGS. 4 to 15.

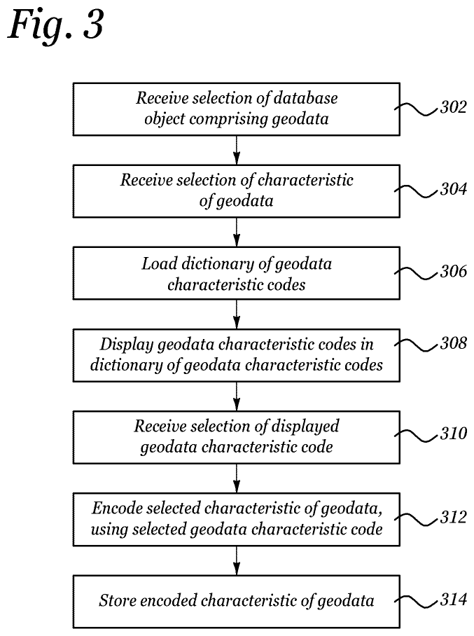

Turning now to FIG. 3, a method is shown schematically. The method, which is computer-implemented, may be performed by the encoding engine 106 described above. In general terms, the steps relate to encoding a characteristic of geodata, using a selected geodata characteristic code.

Turning now to the details of the method, at step 302 a selection of a database object (e.g. database object 102 described above) comprising geodata (e.g. geodata 104 described above) is received. This selection input can involve any suitable form and is typically provided by a user clicking or otherwise selecting a database object 102 from a list of available database objects 102. For example, a user may select a database object 102 via a GUI of the encoding engine 106 upon which available database objects 102 are displayed. After receiving a selection of a database object 102, the encoding engine 106 may, optionally, retrieve the database object 102 from a database (e.g. database 100).

At step 304, a selection of at least one characteristic of the geodata 104 is received. This selection input can again involve any suitable form and is typically provided by a user clicking or otherwise selecting at least one characteristic of the geodata 104 from a list of available characteristics of the geodata 104. A user may select a characteristic of the geodata 104 of the database object 102, for example, via the GUI of the encoding engine 106. After receiving a selection of a characteristic of the geodata 104 of the database object 102, the encoding engine 106 may, optionally, retrieve the characteristic of the geodata 104 of the database object 102 from a database (e.g. database 100). This could occur in instances where the entirety of the database object 102 has not been retrieved in step 302. This could reduce bandwidth and processing requirements as less data is sent between the database 100 and the encoding engine 106.

The method then comprises, at step 306, loading a dictionary (e.g. dictionary 108) of geodata characteristic codes 110. As mentioned above, the dictionary 108 may be stored locally at the encoding engine 106 or it may be stored remotely and accessed by the encoding engine 106 via, for example, a network.

Once the dictionary is loaded the encoding engine 106, optionally, displays geodata characteristic codes 110 of the dictionary 108 via, for example, the aforementioned GUI at step 308. This step may comprise initially displaying a plurality of dictionary entries 112a, 112b, 112c of the dictionary 108. As mentioned above, each dictionary entry 112a, 112b, 112c may correspond to a respective standard, meaning that the geodata characteristic codes 110 contained in each dictionary entry 112a, 112b, 112c all relate to the same standard. A user may first select the dictionary entry 112a, 112b, 112c they want to use resulting in the display of all geodata characteristic codes 110 contained in each dictionary entry 112a, 112b, 112c. In this manner, it can be ensured that only geodata characteristic codes 110 relating to a desired standard are presented to the user. Alternatively, geodata characteristic codes 110 are not displayed and a user may simply input a desired geodata characteristic codes 110, with it only being possible to input geodata characteristic codes 110 that are present in the selected dictionary entry 112a, 112b, 112c.

At step 310, a selection of at least one of the displayed geodata characteristic codes 110, or alternatively an input of a geodata characteristic codes 110, is received. This selection input can again involve any suitable form and is typically provided by a user clicking or otherwise selecting a geodata characteristic code 110 from a list of available geodata characteristic codes 110. For example, a user may select a geodata characteristic code 110 via the GUI of the encoding engine 106.

At step 312, the selected at least one characteristic of the geodata 104 is encoded using the selected geodata characteristic code 110. As mentioned above, each geodata characteristic code 110 may comprise an identifier that is linked to further data elements related to the characteristic of that particular geodata characteristic code 110. The selected at least one characteristic of the geodata 104 can be encoded using the identifier such that the at least one characteristic of the geodata 104 becomes linked to the further data elements related to the characteristic of that particular geodata characteristic code 110.

Finally, at step 314, the encoded characteristic of the geodata is stored. The encoded characteristic could be stored at the database 100, locally at the encoding engine 106 or elsewhere.

As can be seen, the disclosed method provides a simple and intuitive way for characteristics of geodata to be encoded and linked to data elements related to the characteristics. In this manner, the encoded characteristics can be retrieved alongside any data elements linked to the geodata characteristic code 110 used to encode the encoded characteristic in a computationally efficient manner. No programming or other complex inputs are required, the user simply selects the characteristic of the geodata 104 to be encoded along with the desired geodata characteristic code 110, simplifying the process and reducing the likelihood of errors. Geodata from multiple sources and associated with multiple geological entities can be easily and intuitively encoded using one or more geodata characteristic codes 110 stored in the dictionary 108. The fact that the dictionary 108 can comprise a plurality of dictionary entries 112a, 112b, 112c, which each comprise a set of corresponding geodata characteristic codes 110, and may correspond to a respective standard, ensures that geodata characteristics are encoded in a manner that conforms to standards. This ensures that when encoded characteristics are subsequently output, for example, as part of a report, the report will also conform with the standard.

In order to further aid in understanding of the disclosed methods and systems, the above-described functionality will now be showcased in the context of real-world applications wherein the disclosed systems and methods are utilised to select and encode characteristics of geodata 104 in database objects 102. This functionality will now be explained with reference to FIGS. 4-15. FIGS. 4-15 show photographs (screenshots) of a graphical user interface used to implement the disclosed functionality. It will be appreciated that these screenshots are provided with the sole purpose of schematically demonstrating the underlying functionality provided by the systems and methods of the present disclosures. The actual substantive content (text, numbers etc.) of these particular screenshots is not fundamental to understanding the disclosed invention, is non-limiting and will of course change as different geodata is analysed in different real-world contexts. Hence, FIGS. 4-15 should be considered as schematic diagrams exemplifying the disclosed functionality, rather than there being any fundamental importance in the actual data displayed in these specific screenshots. The disclosed functionality is also not limited to use in the shown software but can be implemented using any suitable software.

Turning first to FIGS. 4-7, these figures show how database objects (such as database objects 102 described in reference to FIG. 1) can be configured.

FIG. 4 shows an example user interface panel that may be used to implement some of the disclosed methods. On the left hand side, a database object selection panel 412 (alternatively referred to as a database object selection area) is shown containing list of database objects 402 stored in a database. These database objects 402 are equivalent to database objects 102 described above with reference to FIG. 1. One of the database objects 402 is selected, relating to a borehole log. This database object is denoted GN_A05_BH. A database object configuration panel 414 is shown, comprising a number of data fields in which geodata for the selected database object can be entered, viewed and modified. This data can comprise identification data, location data and geodata of the sort described above with reference to geodata 104.

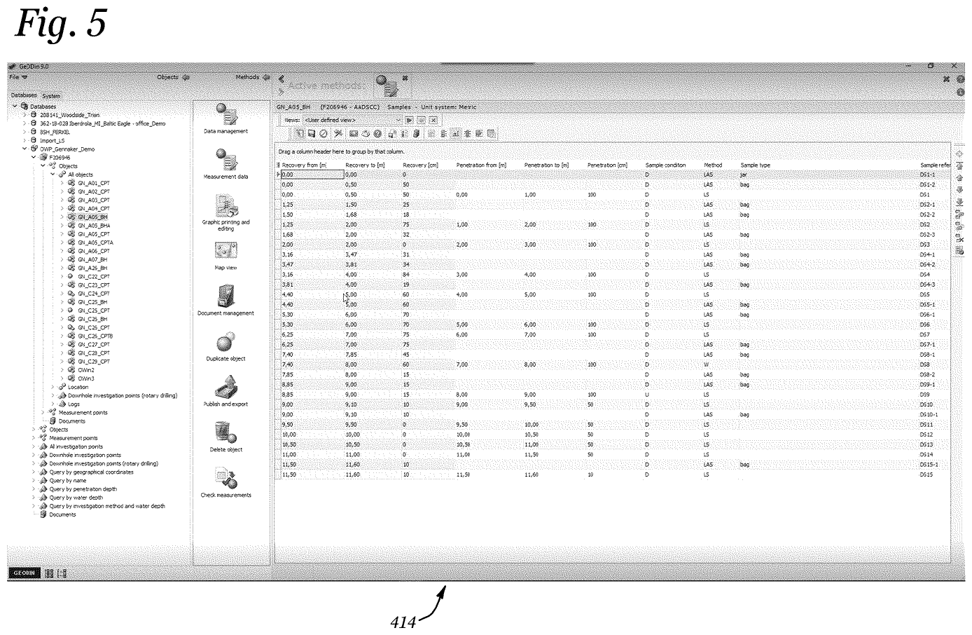

FIG. 5 shows another display tab which can be displayed in database object configuration panel 414 and used to populate the database object with geodata. In this example, borehole layer geodata is shown, providing soil descriptions for different layers of soil corresponding to a plurality of samples obtained from borehole GN_A05 during a soil survey.

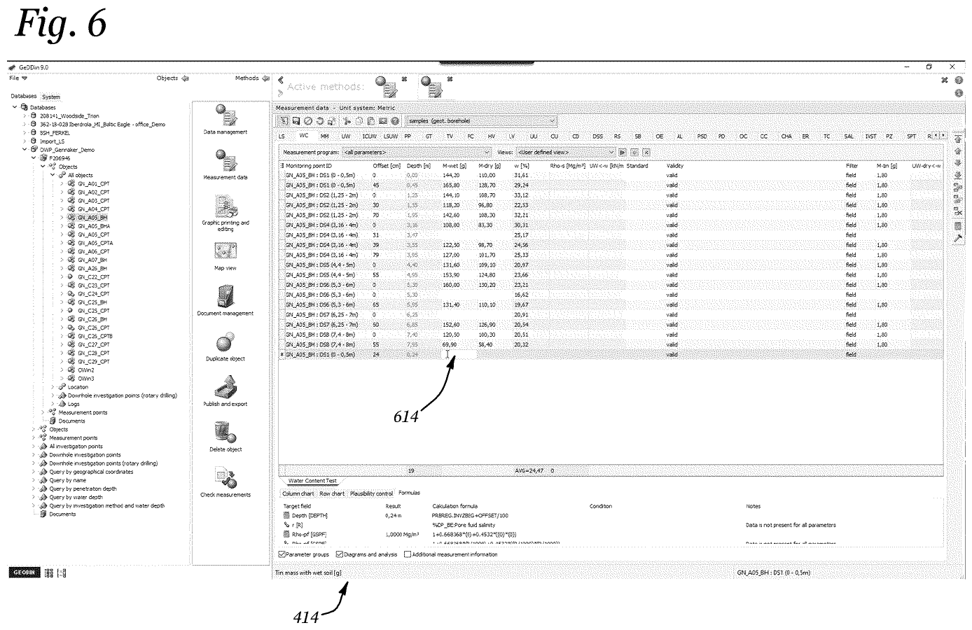

FIG. 6 shows yet another screen which can be displayed in database object configuration panel 414 and used to populate the database object with geodata. In this screen, detailed geodata for soil samples associated with the borehole is provided, including data relating to the depth at which each sample was taken, the wet soil mass of the sample, the dry soil mass of the sample, the moisture content of the sample and other relevant parameters. Note that a user is in the process of adding a new entry of sample data 614 at the bottom of the list of samples. Data can be added manually in this way or populated automatically, for example based on received sensor data.

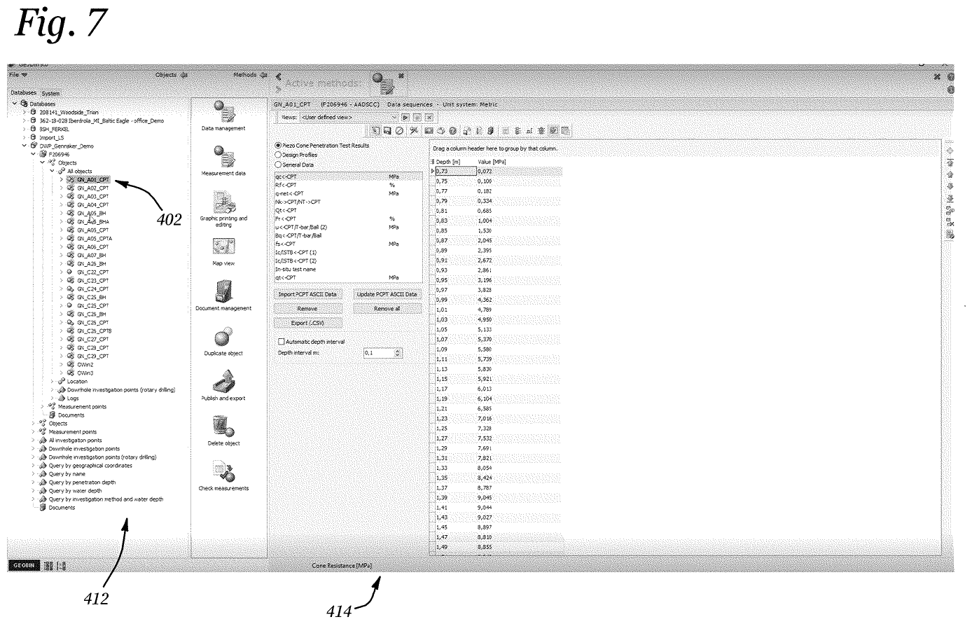

FIG. 7 again shows the database object configuration panel 412, but now a different database object is selected in the left hand object selection panel 412. In particular, now the database object 402 selected relates to CPT test A01, denotes GC_A01_CPT. Accordingly, the fields shown in database object configuration panel 314 now include fields that can be populated with geodata from a CPT test, in this example soil pressure data obtained at a plurality of soil depths. It will be appreciated that, depending on the type of database object 402 selected, the database object configuration panel 414 will contain different appropriate fields to record the associated geodata.

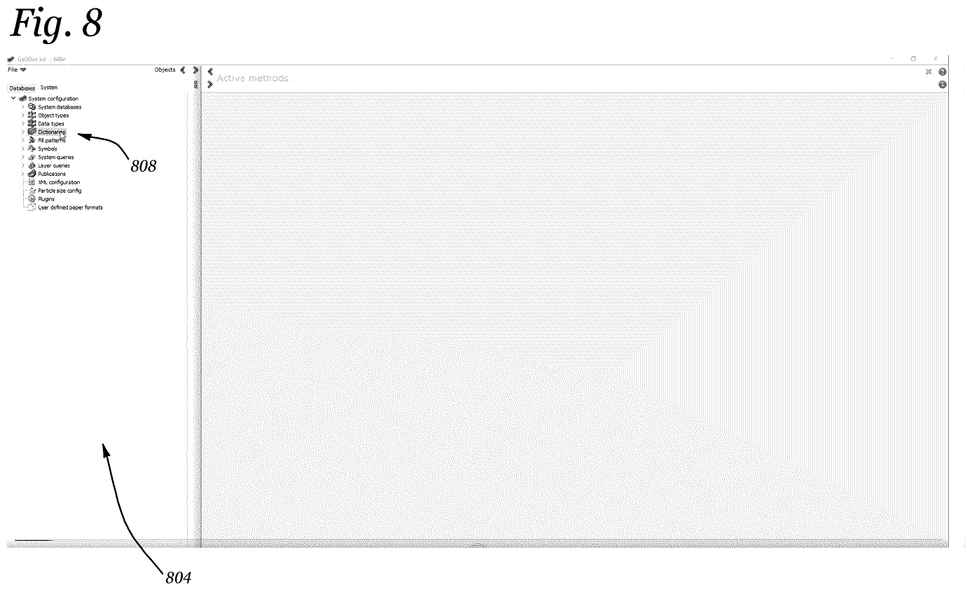

Turning now to FIGS. 8-12, these figures show how a dictionary (such as dictionary 108 described in reference to FIG. 1) is structured.

Turning first to FIG. 8, an example user interface panel is shown that may be used to implement some of the disclosed methods. On the left hand side, a system configuration panel 804 is shown containing a list of system configuration items, one of which is Dictionaries 808 (equivalent to dictionary 108 described in reference to FIG. 1).

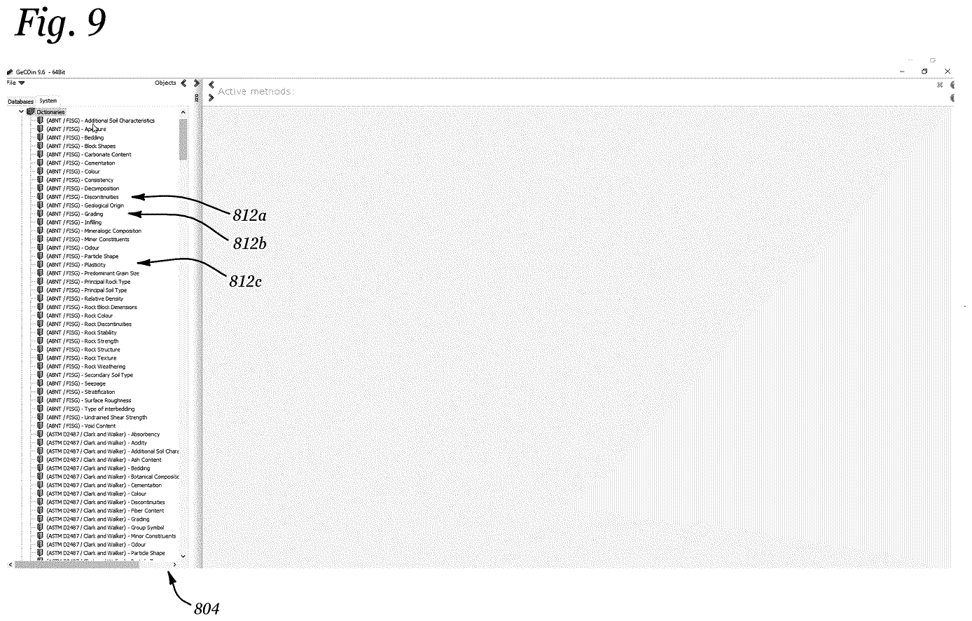

In FIG. 9, the Dictionaries 808 item has been selected and expanded resulting in a list of dictionary entries 812a, 812b, 812c (equivalent to dictionary entries 112a, 112b, 112c described in reference to FIG. 1) being displayed in the system configuration panel 804.

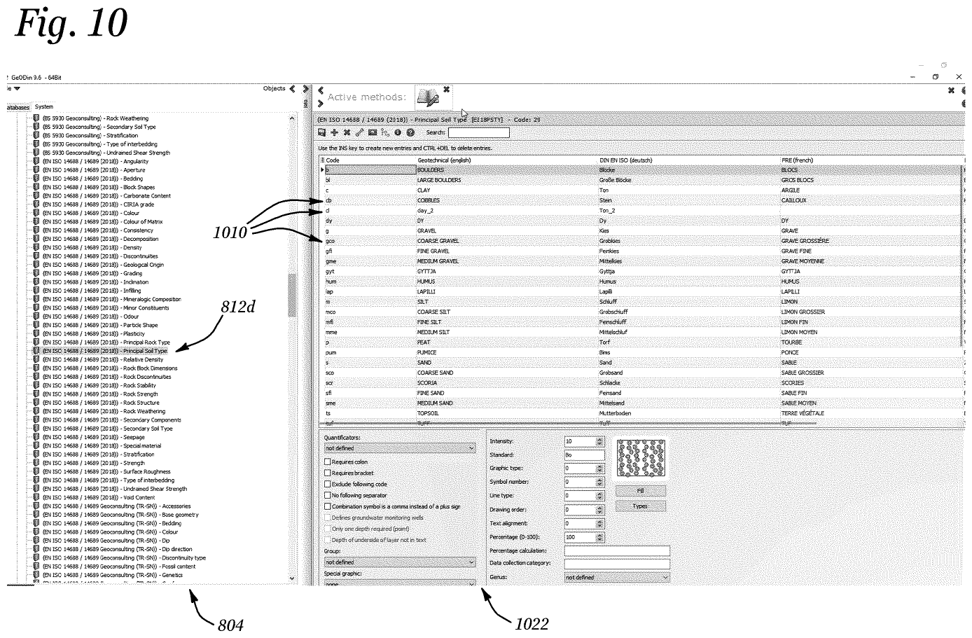

In FIG. 10, a specific dictionary entry 812d has been selected, in this instance a dictionary entry 812d relating to standard EN ISO 14688/14689(2018 )—Principle Soil Type, resulting in the display of geodata characteristic codes 1010 (such as geodata characteristic codes 110 described in reference to FIG. 1) being displayed in a geodata characteristic code display panel 1022. In this example, the geodata characteristic codes 1010 displayed after selection of dictionary entry 812d all conform with standard EN ISO 14688/14689(2018 )—Principle Soil Type.

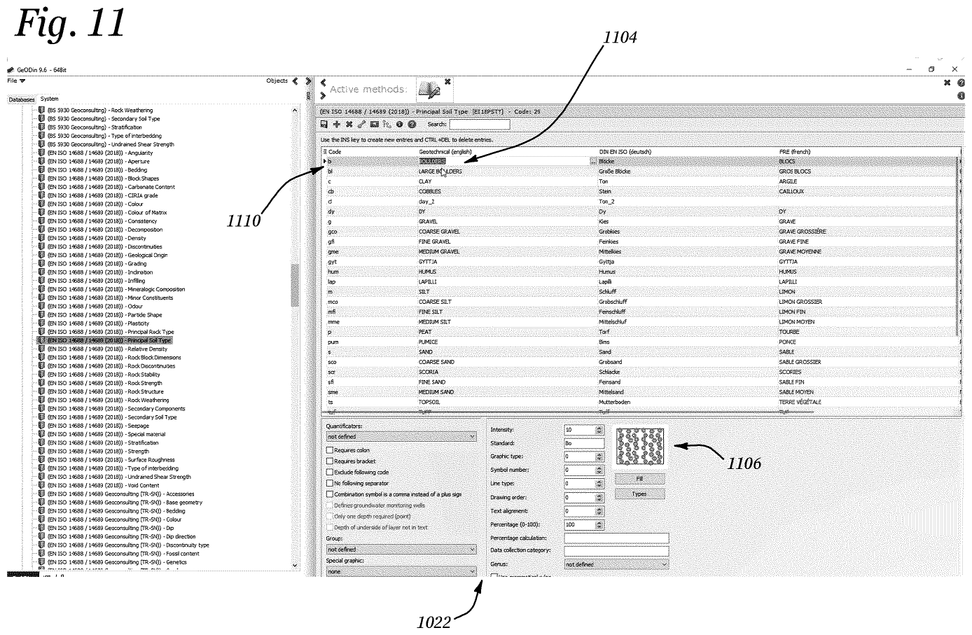

In FIG. 11, a first text string 1104 (such as first text string 204 described in reference to FIG. 2), linked to a first geodata characteristic code “b” 1110 (equivalent to geodata characteristic code 110 described in reference to FIG. 2), has been selected in the geodata characteristic code display panel 1022. This has resulted in the display of a first fill pattern 1106 (equivalent to first fill pattern 206 described in reference to FIG. 2), also linked to the first geodata characteristic code 1110, in a lower region of the geodata characteristic code display panel 1022. Here the first geodata characteristic code 1110 represents a geodata characteristic of principle soil type, which is “boulders”. The first text string 1104 is an English language representation of this geodata characteristic that conforms with an English language version of the standard of the selected dictionary entry 812d, EN ISO 14688/14689(2018 )—Principle Soil Type. First fill pattern 1106 also conforms with the English language version of the standard.

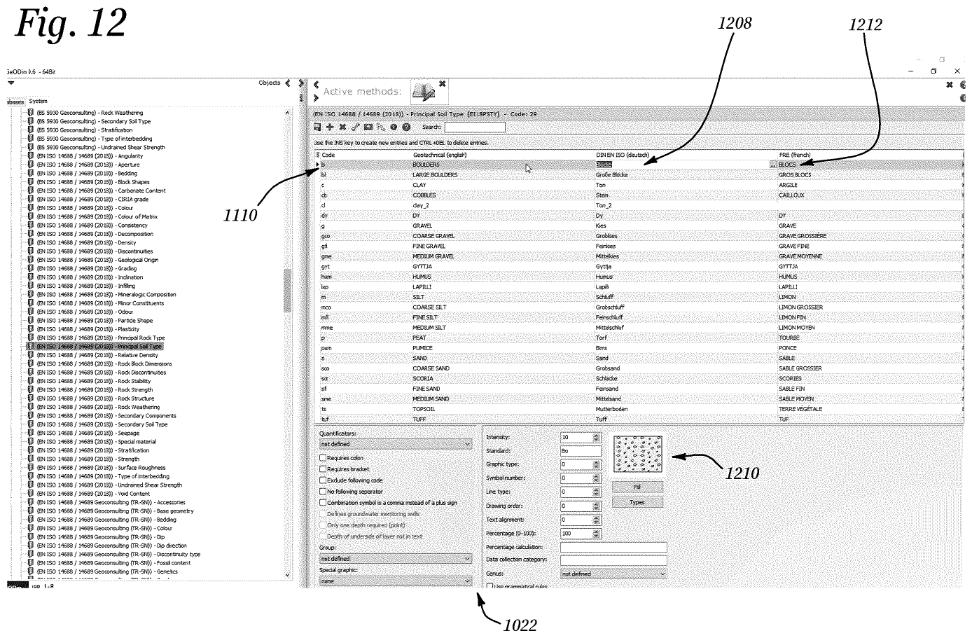

In FIG. 12, a second text string 1208 (equivalent to second text string 208 described in reference to FIG. 2), linked to a first geodata characteristic code “b” 1110, has been selected in the geodata characteristic code display panel 1022. This has resulted in the display of a second fill pattern 1210 (equivalent to second fill pattern 210 described in reference to FIG. 2), also linked to the first geodata characteristic code 1110, in a lower region of the geodata characteristic code display panel 1022. Here the first geodata characteristic code 1110 represents a geodata characteristic of principle soil type, which is “boulders”. The second text string 1208 is a German language representation of this geodata characteristic that conforms with a German language version of the standard of the selected dictionary entry 812d, EN ISO 14688/14689(2018 )—Principle Soil Type. In this example, the second text string 208 takes the form “Blocke”, in other words, a German language representation of the principle soil type characteristic, Boulders, to which the depicted geodata characteristic code 110 relates. The second fill pattern 1210 also conforms with the German language version of the standard, which requires a different graphical representation to the English language version of the standard.

Also visible is a third text string 1212 which is a French language representation of the geodata characteristic of the first geodata characteristic code 1110 that conforms with a French language version of the standard of the selected dictionary entry 812d, EN ISO 14688/14689(2018 )—Principle Soil Type. If selected, a further fill pattern that conforms with the French language version of the standard would be displayed in the lower region of the geodata characteristic code display panel 1022.

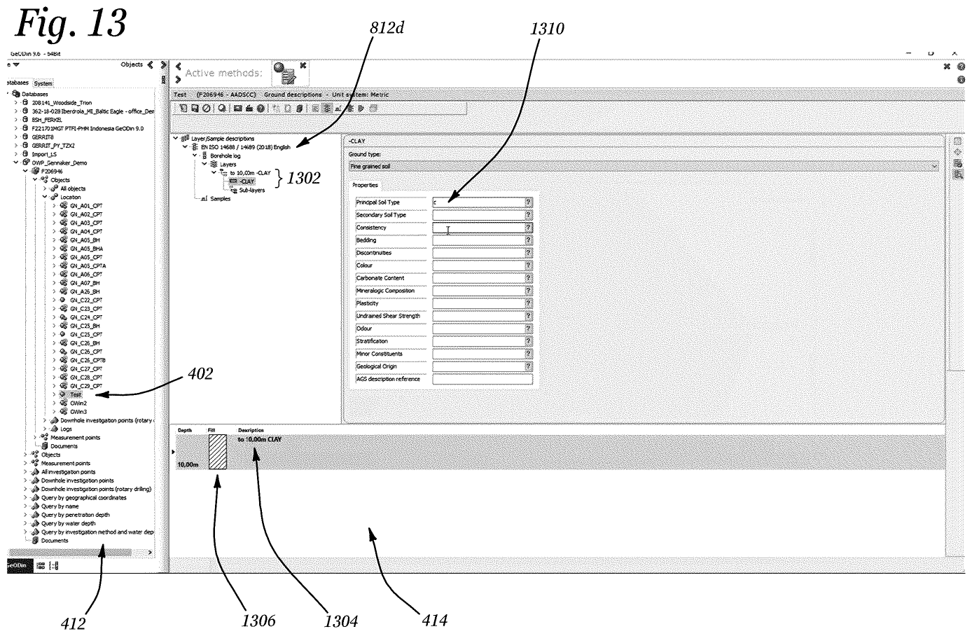

Turning now to FIGS. 13 to 15, these figures show how a characteristic of geodata can be encoded using a geodata characteristic code.

In FIG. 13, a database object 402 to be encoded using one of dictionary entries 812a, 812b, 812c listed in the Dictionaries 808 item has been selected in database object selection panel 412. In this example, a database object 402 titled “Test” has been selected. As can be seen in database object configuration panel 414, dictionary entry 812d EN ISO 14688/14689(2018 ) has been selected, meaning that only geodata characteristic codes conforming with this standard will be presented to the user or, alternatively, only geodata characteristic codes conforming with this standard may be input by the user where the geodata characteristic codes are not displayed. As can be seen in database object configuration panel 414, the database object 402 titled “Test” relates to a “Borehole log” having “Layers”. In this example, the database object 402 relates to borehole layer geodata in which different layers of soil corresponding to a plurality of samples obtained from borehole titled “Test” during a soil survey are to be encoded.

A particular geodata characteristic 1302 of the geodata of the database object 402, in this example the layer titled “to 10,00 m-CLAY”, has been selected to be encoded using a geodata characteristic code. As can be seen, geodata characteristic code 1310 “c” has been selected to encode the selected geodata characteristic 1302. The geodata characteristic 1302 has been encoded using the geodata characteristic code 1310 “c”, which represents the geodata characteristic of principle soil type, which is “clay” in this example. The first text string 1304, in this example “CLAY” and corresponding first fill pattern 1306 linked to the geodata characteristic code 1310 are displayed in the lower portion of database object configuration panel 414. Other data items as described herein, such as further text strings and further fill patterns, may also be linked to geodata characteristic code 1310 “c”, but are not displayed. All data items, including first text string 1304 and first fill pattern 1306, linked to the geodata characteristic code 1310 “c” will be in conformity with the selected dictionary entry 812d standard.

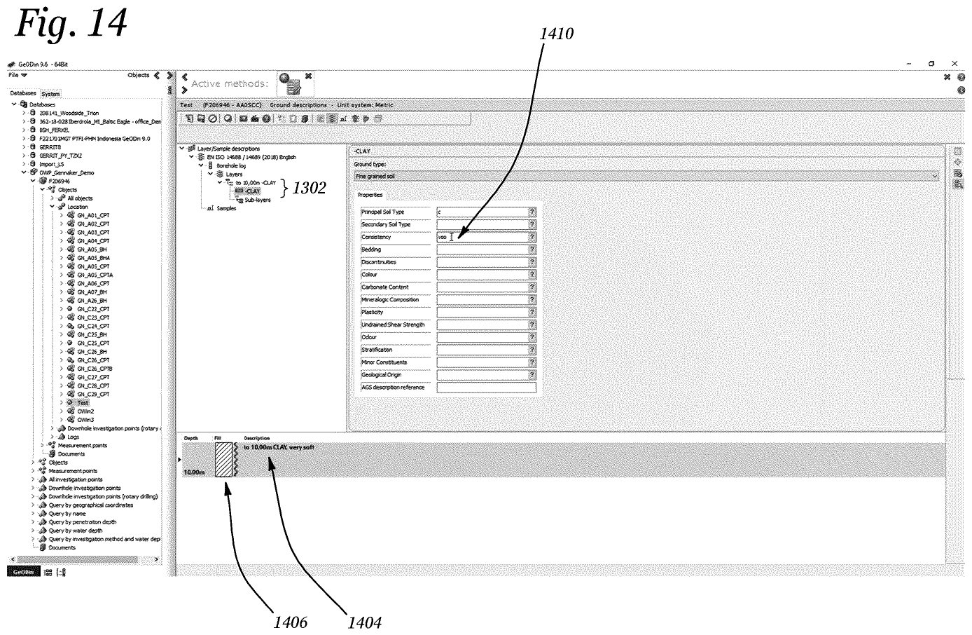

In FIG. 14, the geodata characteristic 1302 of the geodata of the database object 402 has been encoded using a further geodata characteristic code 1410 “vso”, which represents the geodata characteristic of consistency, which is “very soft” in this example. The first text string 1404, in this example “very soft”, and corresponding first fill pattern 1404 linked to the geodata characteristic code 1410 are displayed in the lower portion of database object configuration panel 414 alongside first text string 1304 “CLAY” and corresponding first fill pattern 1306. This is an example of the same geodata characteristic 1302 of the geodata of the database object 402 being encoded with multiple geodata characteristic codes 1310 and 1410.

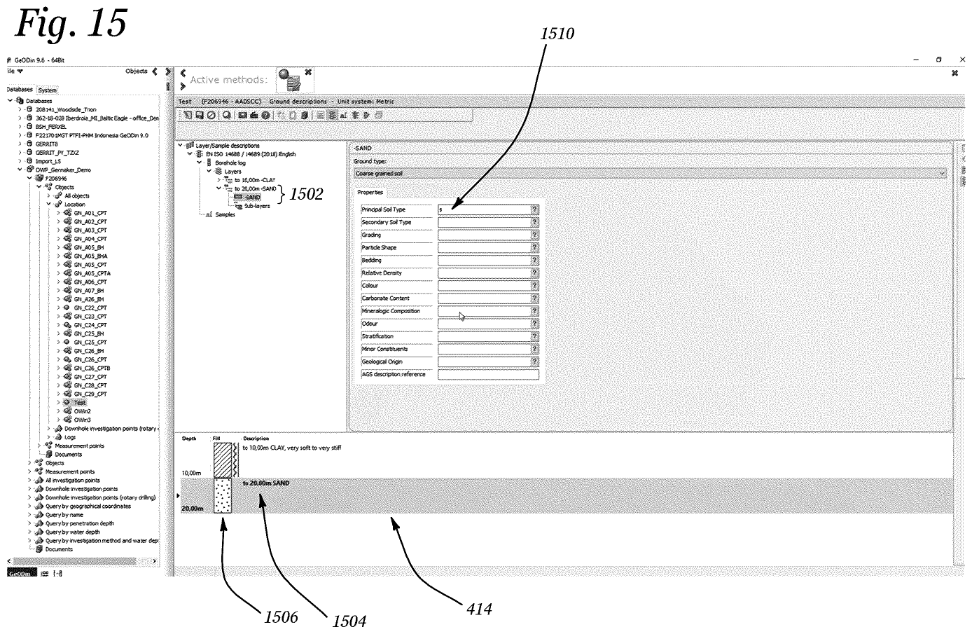

In FIG. 15, a further geodata characteristic 1502 of the geodata of the database object 402, in this example the layer titled “to 20,00 m-SAND”, has been selected to be encoded using a geodata characteristic code. As can be seen, geodata characteristic code 1510 “s” has been selected to encode the selected geodata characteristic 1502. The geodata characteristic 1502 has been encoded using the geodata characteristic code 1510 “s”, which represents the geodata characteristic of principle soil type, which is “sand” in this example. The first text string 1504, in this example “SAND” and corresponding first fill pattern 1506 linked to the geodata characteristic code 1310 are displayed in the lower portion of database object configuration panel 414 alongside other data items liked to geodata characteristic codes 1310 and 1410. Again, the data items of the geodata characteristic code 1510 all conform with the selected standard.

Accordingly, FIGS. 13-15 show examples of how the steps 302-314 of FIG. 3 described above may be implemented.

FIG. 16 shows a block diagram of one implementation of a computing device 1600 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

Further, while only a single computing device is illustrated, the term “computing device” shall also be taken to include any collection of machines (e.g., computers) that individually or jointly execute a set (or multiple sets) of instructions to perform any one or more of the methodologies discussed herein. More particularly, a number of computing devices can be used to compute cross-correlations of signal data subsets independently and in parallel, as described above. Each computing device may have the structure shown in FIG. 16. Alternatively, a plurality of processors within a single computing device, such as computing device 1600, can perform the independent computations.

The example computing device 1600 includes a processor 1602, a main memory 1604 (e.g., read-only memory (ROM), flash memory, dynamic random-access memory (DRAM) such as synchronous DRAM (SDRAM) or Rambus DRAM (RDRAM), etc.), a static memory 1606 (e.g., flash memory, static random access memory (SRAM), etc.), and a secondary memory (e.g., a data storage device 1618), which communicate with each other via a bus 1630.

Processor 1602 represents one or more general-purpose processors such as a microprocessor, central processing unit, or the like. More particularly, the processor 1602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1602 may also be one or more special-purpose processors such as an application specific integrated circuit (ASIC), a field programmable gate array (FPGA), a digital signal processor (DSP), network processor, or the like. Processor 1602 is configured to execute the processing logic (instructions 1622) for performing the operations and steps discussed herein.

The computing device 1600 may further include a network interface device 1608. The computing device 1600 also may include a video display unit 1610 (e.g., a liquid crystal display (LCD) or a cathode ray tube (CRT)), an alphanumeric input device 1612 (e.g., a keyboard or touchscreen), a cursor control device 1614 (e.g., a mouse or touchscreen), and an audio device 1616 (e.g., a speaker).

It will be apparent that some features of computer device 1600 shown in FIG. 16 may be absent. For example, one or more computing devices 1600 may have no need for display device 1610 (or any associated adapters). This may be the case, for example, for particular server-side computer apparatuses 1600 which are used only for their processing capabilities and do not need to display information to users. Similarly, user input device 1612 may not be required. In its simplest form, computing device 1600 comprises processor 1602 and memory 1604.

The data storage device 1618 may include one or more machine-readable storage media (or more specifically one or more non-transitory computer-readable storage media) 1628 on which is stored one or more sets of instructions 1622 embodying any one or more of the methodologies or functions described herein. The instructions 1622 may also reside, completely or at least partially, within the main memory 1604 and/or within the processor 1602 during execution thereof by the computer system 1600, the main memory 1604 and the processor 1602 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAS, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method of encoding and storing geodata, the method comprising:
receiving a selection of a database object comprising geodata;
receiving a selection of at least one characteristic of the geodata;
loading a dictionary of geodata characteristic codes;
receiving a selection of a geodata characteristic code in the dictionary of geodata characteristic codes;
encoding the selected of the least one characteristic of the geodata, using the selected geodata characteristic code; and
storing the encoded characteristic of the geodata.

2. The computer-implemented method of claim 1, wherein the selected geodata characteristic code is linked to a first text string related to the characteristic of the selected geodata characteristic code.

3. The computer-implemented method of claim 2, wherein the selected geodata characteristic code is linked to a second text string related to the characteristic of the selected geodata characteristic code and in a different language to the first text string.

4. The computer-implemented method of claim 1, wherein the selected geodata characteristic code is linked to a fill pattern related to the characteristic of the selected geodata characteristic code.

5. The computer-implemented method of claim 3, wherein a respective fill pattern related to the characteristic of the selected geodata characteristic code is linked to each of the first text string and the second text string.

6. The computer-implemented method of claim 1, further comprising:
displaying the geodata characteristic codes in the dictionary of geodata characteristic codes, wherein receiving the selection of the geodata characteristic code in the dictionary of geodata characteristic codes comprises receiving a selection of a displayed geodata characteristic code.

7. The computer-implemented method of claim 6, further comprising:
receiving a selection of a standard,
wherein the displaying geodata characteristic codes in the dictionary of geodata characteristic codes comprises displaying a subset of the geodata characteristic codes in the dictionary of geodata characteristic codes that conform with the standard,
wherein the selected geodata characteristic code is selected from the displayed subset of geodata characteristic codes that conform with the standard.

8. The computer-implemented method of claim 1, further comprising:
receiving a selection of a layer in a geological entity associated with the geodata of the database object, wherein receiving the selection of the characteristic of the geodata comprises receiving a selection of a characteristic of the layer.

9. The computer-implemented method of claim 1, wherein the geodata comprises data obtained from a plurality of data sources.

10. The computer-implemented method of claim 1, further comprising:
receiving a selection of a second characteristic of the geodata;
receiving a selection of a second geodata characteristic code in the dictionary of geodata characteristic codes;
encoding the selected second characteristic of the geodata, using the selected second geodata characteristic code; and
storing the encoded second characteristic of the geodata.

11. The computer-implemented method of claim 10, further comprising receiving a selection of a second layer in a geological entity associated with the geodata of the database object,
wherein receiving the selection of the second characteristic of the geodata comprises receiving a selection of a characteristic of the second layer.

12. The computer-implemented method of claim 1, further comprising:
receiving a selection of a third geodata characteristic code, wherein the selected characteristic of the geodata is encoded using the selected geodata characteristic code and the selected third geodata characteristic code.

13. The computer-implemented method of claim 12, wherein the selected third geodata characteristic code is linked to a third fill pattern related to the characteristic of the selected third geodata characteristic code.

14. The computer-implemented method of claim 1, further comprising:
receiving an instruction to output a report comprising the geodata of the database object;
retrieving the encoded characteristic of the geodata;
decoding the encoded characteristic of the geodata to obtain data linked to the encoded characteristic of the geodata; and
outputting the linked data in the report.

15. A system comprising:
one or more processors; and
one or more memories having stored thereon computer-readable instructions, which when executed by the one or more processors cause the one or more processors to:
receive a selection of a database object comprising geodata;
receive a selection of at least one characteristic of the geodata;
load a dictionary of geodata characteristic codes;
receive a selection of a geodata characteristic code in the dictionary of geodata characteristic codes;
encode the selected of the least one characteristic of the geodata, using the selected geodata characteristic code; and
store the encoded characteristic of the geodata.

16. The system of claim 15, wherein the selected geodata characteristic code is linked to a first text string related to the characteristic of the selected geodata characteristic code.

17. The system of claim 16, wherein the selected geodata characteristic code is linked to a second text string related to the characteristic of the selected geodata characteristic code and in a different language to the first text string.

18. The system of claim 17, wherein a respective fill pattern related to the characteristic of the selected geodata characteristic code is linked to each of the first text string and the second text string.

19. The system of claim 15, wherein the selected geodata characteristic code is linked to a fill pattern related to the characteristic of the selected geodata characteristic code.

20. The system of claim 15, further comprising:
displaying the geodata characteristic codes in the dictionary of geodata characteristic codes, wherein receiving the selection of the geodata characteristic code in the dictionary of geodata characteristic codes comprises receiving a selection of a displayed geodata characteristic code.
